(19) United States
(12) Patent Application Publication
(10) Pub. No.: US 2020/0067931 A1
(43) Pub. Date: Feb. 27, 2020

(54) Shared Data within a Family

(71) Applicant: Apple Inc., Cupertino, CA (US)

(72) Inventors: Christopher D. Espinosa, Menlo Park, CA (US); Lestat Ali, Sunnyvale, CA (US); Claire Marie Tokar, Cupertino, CA (US); Edward Voas, Mountain View, CA (US); Guyerik Bready Fullerton, San Jose, CA (US); Kevin Edwin Ridsdale, San Francisco, CA (US); Maria D. Ioveva, Menlo Park, CA (US); Scott Joseph Adler, Saratoga, CA (US)

(21) Appl. No.: 16/673,247

(22) Filed: Nov. 4, 2019

Related U.S. Application Data
(63) Continuation of application No. 14/724,714, filed on May 28, 2015.
(60) Provisional application No. 62/005,723, filed on May 30, 2014.
(60) Provisional application No. 62/005,171, filed on May 30, 2014.

(51) Int. Cl. H04L 29/06; G06Q 20/38; G06F 21/62

(52) U.S. Cl. CPC H04L 63/102; H04L 63/104; G06F 21/6245; G06Q 20/382

(57) ABSTRACT

One or more user accounts can be linked together to form a group of linked user accounts. A shared calendar can be assigned to a group of linked user accounts. A shared calendar can be a unique calendar assigned to the group of linked user accounts that can be accessed by each member of the group of linked user accounts to schedule appointments, reminders, etc. A shared task list can be assigned to a group of linked user accounts and accessed by each member of the group of linked user accounts. Members of the group of linked user accounts can add tasks to the shared task list that can then be viewed by the other members of the group of linked user accounts. This can allow a family to add tasks to the shared task list that can then be completed by other members of the family.

### RELATED APPLICATIONS

This application is a continuation of U.S. application Ser. No. 14/724,714, entitled “SHARED DATA WITHIN A FAMILY,” filed on May 28, 2015, which claims the benefit of U.S. Provisional Application No. 62/005,171, entitled “SHARED CALENDAR,” filed on May 30, 2014, and U.S. Provisional Application No. 62/005,723, entitled “SHARED LOCATION DATA,” filed on May 30, 2014, all of which are hereby expressly incorporated by reference in their entirety.

### TECHNICAL FIELD

The present technology pertains to calendars, and more specifically pertains to a shared calendar assigned to a group of linked user accounts.

### BACKGROUND

Computing devices have become a common part of daily life. For example, many families have a separate computing device for each family member. This can include desktop computers, laptops, smart phones, tablet PCs, etc. Along with the increased number of computing devices, computing devices also allow users to perform a wider range of functionality. For example, computing devices can connect to the internet from multiple locations to access various types of content, such as video, music, images, etc.

Computing devices can also be used to manage users' day-to-day lives. For example, calendar applications allow users to schedule their appointments and receive reminders from a variety of computing devices. While these calendar applications make it easy for a user to schedule their appointments and tasks, it can still be difficult to synchronize appointments and tasks amongst numerous users. Accordingly, improvements are needed.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, devices, and non-transitory computer-readable storage media for managing a shared calendar assigned to a group of linked user accounts. One or more user accounts can be linked together to form a group of linked user accounts. When linked, the user accounts in the group of linked user accounts can access content items assigned to the other user accounts in the group of linked user accounts. This can allow family members to link their accounts into a group of linked user accounts to share their purchases, photos, etc. with the other members of their family.

In some embodiments, a shared calendar can be assigned to a group of linked user accounts. A shared calendar can be a unique calendar assigned to the group of linked user accounts that can be accessed by each member of the group of linked user accounts. This can allow the members of the group of linked user accounts to easily schedule appointments that can be seen by each member of the group of linked user accounts. Further, members of the group of linked user accounts can receive reminders regarding the scheduled events.

In some embodiments, a shared task list can be assigned to a group of linked user accounts. A shared task list can be a unique task list assigned to the group of linked user accounts that can be accessed by each member of the group of linked user accounts. Members of the group of linked user accounts can add tasks to the shared task list that can then be viewed by the other members of the group of linked user accounts. This can allow a family to add tasks to the shared task list that can then be completed by other members of the family.

In some embodiments, location data gathered from the members of the group of linked user accounts can be shared with the other members of the group of linked user accounts. Location data for a user account can include the location of client devices authorized on the user account. The location data gathered from the members of the group of linked user accounts can be shared such that each member of the group of linked user accounts can access the location data gathered from the other members of the group of linked user accounts.

In some embodiments, this process can be performed automatically such that when a group of linked user accounts is created, the members of the group of linked user accounts automatically receive location data gathered from the other members of the group of linked user accounts. Likewise, the list of user accounts from which location data is gathered can be dynamic and automatically update with membership of the group of linked user accounts. For example, as members join and leave the group of linked user accounts, the list of user accounts from which location data is gathered can be automatically modified accordingly.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network in accordance with the invention;

FIGS. 2A, 2B, and 2C illustrate an exemplary embodiment of linking multiple user accounts together;

FIG. 3 illustrates an exemplary method embodiment of automatically generating a shared calendar for a group of linked user accounts;

FIG. 4 illustrates an exemplary method embodiment of creating a group of linked user accounts;

FIG. 5 illustrates an exemplary method embodiment of automatically generating a shared calendar for a group of linked user accounts;

FIG. 6 illustrates an exemplary method embodiment of automatically updating user accounts that are sharing location data with each other; and

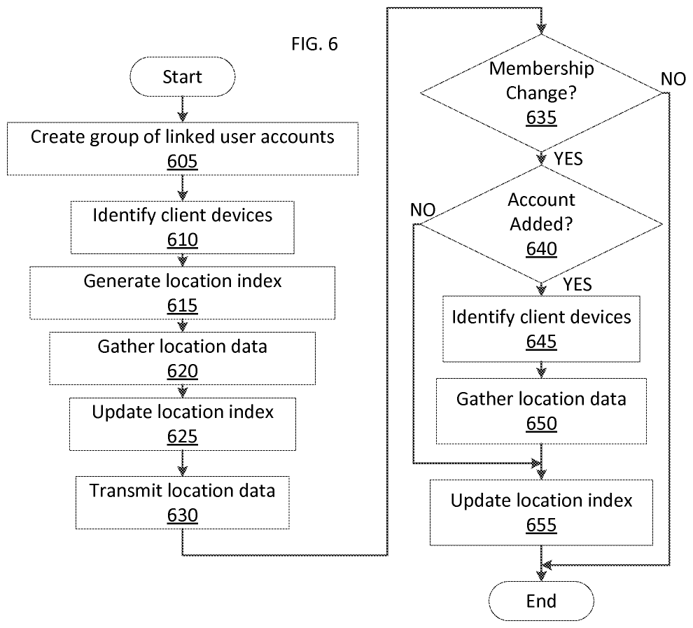

FIGS. 7A and 7B illustrate exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for managing a shared calendar assigned to a group of linked user accounts. One or more user accounts can be linked together to form a group of linked user accounts. When linked, the user accounts in the group of linked user accounts can access content items assigned to the other user accounts in the group of linked user accounts. This can allow family members to link their accounts into a group of linked user accounts to share their purchases, photos, etc. with the other members of their family.

In some embodiments, a shared calendar can be assigned to a group of linked user accounts. A shared calendar can be a unique calendar assigned to the group of linked user accounts that can be accessed by each member of the group of linked user accounts. This can allow the members of the group of linked user accounts to easily schedule appointments that can be seen by each member of the group of linked user accounts. Further, members of the group of linked user accounts can receive reminders regarding the scheduled events.

In some embodiments, a shared task list can be assigned to a group of linked user accounts. A shared task list can be a unique task list assigned to the group of linked user accounts that can be accessed by each member of the group of linked user accounts. Members of the group of linked user accounts can add tasks to the shared task list that can then be viewed by the other members of the group of linked user accounts. This can allow a family to add tasks to the shared task list that can then be completed by other members of the family.

In some embodiments, location data gathered from the members of the group of linked user accounts can be shared with the other members of the group of linked user accounts. Location data for a user account can include the location of client devices authorized on the user account. The location data gathered from the members of the group of linked user accounts can be shared such that each member of the group of linked user accounts can access the location data gathered from the other members of the group of linked user accounts.

In some embodiments, this process can be performed automatically such that when a group of linked user accounts is created, the members of the group of linked user accounts automatically receive location data gathered from the other members of the group of linked user accounts. Likewise, the list of user accounts from which location data is gathered can be dynamic and automatically update with membership of the group of linked user accounts. For example, as members join and leave the group of linked user accounts, the list of user accounts from which location data is gathered can be automatically modified accordingly.

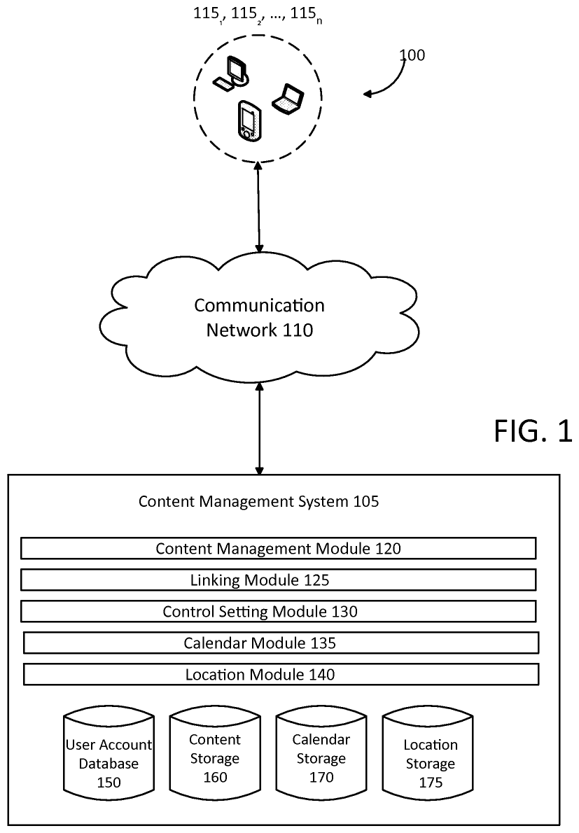

FIG. 1 illustrates an exemplary system configuration 100, wherein electronic devices communicate via a network for purposes of exchanging content and other data. As illustrated, multiple computing devices (client devices 115 and content management system 105) can be connected to communication network 110 and be configured to communicate with each other through use of communication network 110. Communication network 110 can be any type of network, including a local area network (“LAN”), such as an intranet, a wide area network (“WAN”), such as the interne, or any combination thereof. Further, communication network 110 can be a public network, a private network, or a combination thereof. Communication network 110 can also be implemented using any number of communications links associated with one or more service providers, including one or more wired communication links, one or more wireless communication links, or any combination thereof. Additionally, communication network 110 can be configured to support the transmission of data formatted using any number of protocols.

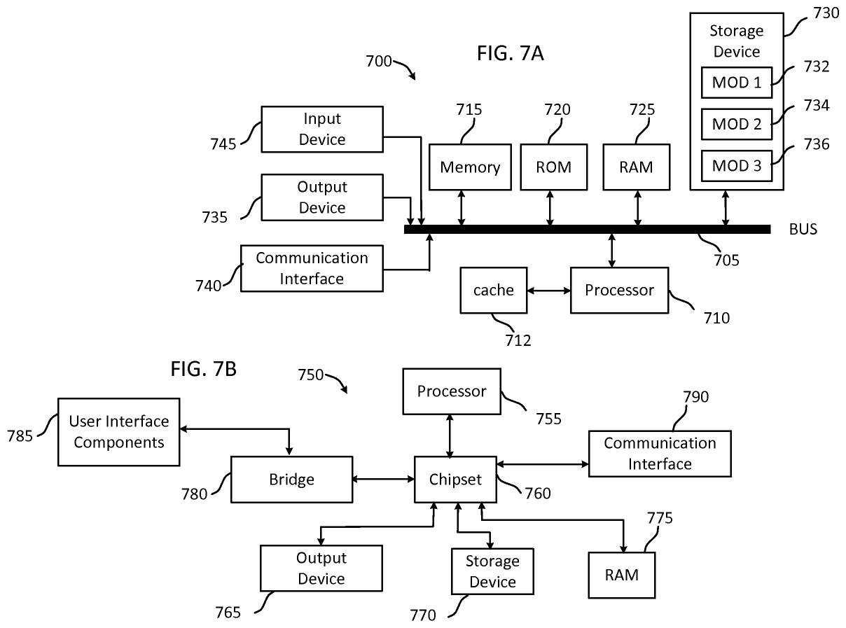

Multiple computing devices can be connected to communication network 110. A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 700 of FIGS. 7A and 7B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

In system 100, a user can interact with content management system 105 through client devices 115₁, 115₂, . . . , 115ₙ (collectively “115”) connected to communication network 110 by direct and/or indirect communication. Content management system 105 can support connections from a variety of different client devices 115, such as desktop computers; mobile computers; mobile communications devices, e.g. mobile phones, smart phones, tablets; smart televisions; set-top boxes; and/or any other network enabled computing devices. Client devices 115 can be of varying type, capabilities, operating systems, etc. Furthermore, content management system 105 can concurrently accept connections from and interact with multiple client devices 115.

A user can interact with content management system 105 via a client-side application installed on client device 115ᵢ. In some embodiments, the client-side application can include a content management system specific component. For example, the component can be a stand-alone application, one or more application plug-ins, and/or a browser extension. However, the user can also interact with content management system 105 via a third-party application, such as a web browser, that resides on client device 115ᵢ and is configured to communicate with content management system 105. In either case, the client-side application can present a user interface (UI) for the user to interact with content management system 105. For example, the user can interact with the content management system 105 via a client-side application integrated with the file system or via a webpage displayed using a web browser application.

Content management system 105 can be configured to manage content items for multiple user accounts. For example, content management system 105 can allow users to purchase, store and access content items. Furthermore, content management system 105 can make it possible for a user to access the content items from multiple client devices 115. Accessing a content item can include receiving metadata describing the content item, streaming the content item from content management system 105, downloading the content item or purchasing the content item.

To facilitate the various content management services, a user can create a user account with content management system 105. The account information for each created user account can be maintained in user account database 150. User account database 150 can store profile information for each user account, including a unique account identifier identifying the user account, personal information, username, password, email address, address, credit card information, banking information, client devices belonging to the user, etc. User account database 150 can also include account management information, such as content storage locations, security settings, personal configuration settings, client devices authorized to access the user account, etc.

A user account can be used to purchase, manage and store content items, such as digital data, documents, text files, audio files, video files, image files, etc. In some embodiments, a content item can be an item that is subject to a licensing restriction. For example, content management system 105 can provide an online content store where users can purchase a variety of content items. Further, in some embodiments, a user can upload content items from one of client devices 115 to content management system 105. The purchased and uploaded content items can be assigned to the user's user account and then accessed by the user from any of client devices 115 when logged into the user's user account. For example, a content item identifier identifying each content item assigned to a user account can be stored in user account database 150 and associated with the corresponding user account. The content item identifier can be used to identify the content item as well as the location of the content item.

The content items can be stored in content storage 160. Content storage 160 can be a storage device, multiple storage devices, or a server. Alternatively, content storage 160 can be a cloud storage provider or network storage accessible via one or more communications networks. Content management system 105 can hide the complexity and details from client devices 115 so that client devices 115 do not need to know exactly where the content items are being stored by content management system 105. Content management system 105 can store the content items in a network accessible storage (NAS) device, in a redundant array of inexpensive disks (RAID), etc. Content storage 160 can store content items using one or more partition types, such as FAT, FAT32, NTFS, EXT2, EXT3, EXT4, ReiserFS, BTRFS, and so forth.

Content storage 160 can also store metadata describing content items, content item types, and the relationship of content items to various user accounts. The metadata for a content item can be stored as part of the content item or can be stored separately. In one variation, each content item stored in content storage 160 can be assigned a system-wide unique identifier.

Content management system 105 can include content management module 120 configured to manage and access each user account and the content items assigned to the user accounts. For example, content management module 120 can be configured to communicate with user account database 150 and content storage 160 to adjust privileges with respect to content items and otherwise manage content items.

A user can communicate with content management system 105 via client device 115ᵢ to request to login into their user account. Content management system 105 can require that a user provide login credentials, such as a user name and password, to login into their user account. Upon receiving the correct login credentials for a user account, content management system 105 can authorize the requesting user's client device 115ᵢ on the user account, thereby allowing client device 115ᵢ to access content items assigned to the user account, make purchases with the payment method associated with the user account, assign content items to the user account, upload content items, etc.

In some embodiments, content management system 105 can limit the number of user accounts on which a client device 115 can be authorized at a time. For example, content management system 105 can limit a client device to being authorized on no more than one user account at a time. This can require a client device 115ᵢ to log out of a user account prior to logging into a different user account, thereby authorizing the client device on the different user account.

While content management system 105 can be configured to limit client devices 115 to being authorized on only one user account at a time, content management system 105 can allow for multiple client devices 115 to be authorized on the same user account simultaneously. This can allow a user to access their user account from multiple devices, such as their tablet PC, desktop PC and smartphone.

Upon a user logging into their user account from client device 115ᵢ, thereby authorizing client device 115ᵢ, on their user account, content management module 120 can access the account information associated with the user account to identify the content items assigned to the user account, as well as account configuration data dictating presentation of the content items. Content management module 120 can then present and/or provide the content items to client device 115ᵢ, according to the account configuration data. For example, content management module 120 can access a user account to identify the content item identifiers assigned to the user account. The content item identifier can then be used to identify and locate the content items assigned to the user account, which can be transmitted to client device 115ᵢ, where they can be presented according to the account configuration data.

Presenting the content items can include transmitting metadata describing the content items to client device 105, that is authorized on the user account. Client device 105, can then use the received metadata to present the content items that the user account can access. For example, client device 105, can present information identifying the content items in a content item library available to the user account. This can include presenting the title of the content item, an image such as an album or book cover, description, etc.

Content management module 120 can also assign content items to a user account. For example, upon a user purchasing or uploading a content item, content management module 120 can add a content item identifier identifying the purchased content item to the user account in account database 150, thus enabling the user account to access the content item.

In some embodiments, content management system 105 can be configured to link multiple user accounts together to form a group of linked user accounts so that content items assigned to each of the individual user accounts can be accessed by each of the user accounts in the group linked user account. This can allow family members to link their user accounts together to share their content items with each other, while maintaining their personal user account.

To link user accounts together, content management system 105 can include linking module 125. In some embodiments, linking module 125 can be configured to provide an account link interface that enables a user to link their user account to other user accounts. For example, the account link interface can enable a user to request that their user account be linked to another user account and/or accept a request received from another user account. Upon logging into their user account, a user can use the account link interface to link their user account to the user account of other users.

To link multiple user accounts together, linking module 125 can be configured to modify the account information of the linked user accounts to indicate that the user accounts are linked together. For example, in some embodiments, linking module 125 can modify a user account to include the unique account identifier of each user account linked to the user account. Account management module 120 can then access a user account to identify each of the user accounts linked to the user account. Likewise, to unlink a user account, linking module 125 can modify the user account of each linked user account to remove the unique account identifier of the user accounts that are no longer linked.

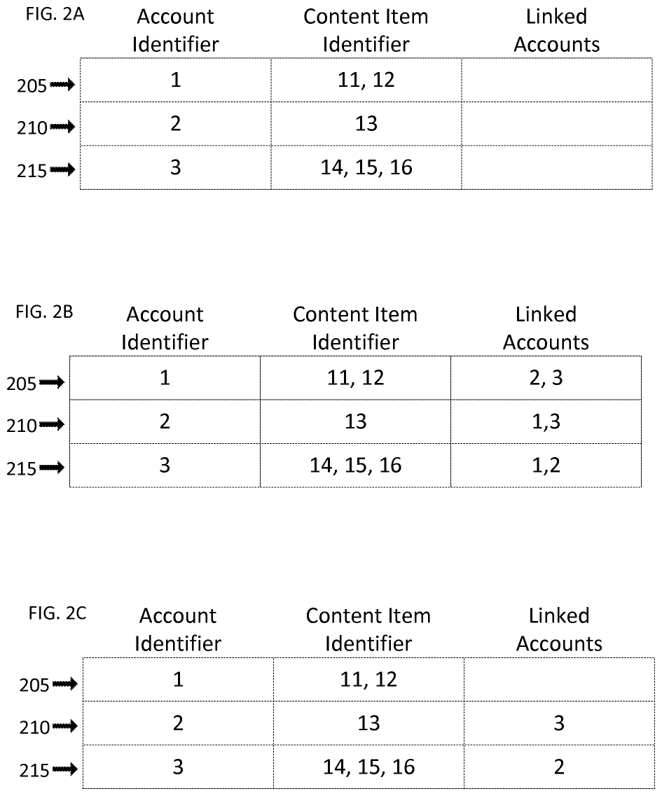

FIGS. 2A-2C illustrate an exemplary embodiment of linking multiple user accounts together. FIG. 2A, illustrates three user accounts: user account 205, user account 210 and user account 215. As shown, each user account (205, 210, 215) includes a unique account identifier field, a content item identifier field and a linked account field.

The unique account identifier field can include a unique account identifier that uniquely identifies a user account. As shown, the unique account identifier for user account 205 is 1; the unique account identifier for user account 210 is 2; and the unique account identifier for user account 215 is 3.

The content item identifier field can include content item identifiers identifying each content item assigned to the individual user account. As shown, content items 11 and 12 are assigned to user account 205, content item 13 is assigned to user account 210, and content items 14, 15 and 16 are assigned to user account 215.

The linked account field can identify the user accounts linked to a user account. For example, the linked account field can include the unique account identifier of each user account linked to the user account. As shown, none of the three user accounts (205, 210, 215) has a unique identifier in their respective linked account field, indicating that none of the user accounts (205, 210, 215) are linked to another user account. Each of the user accounts (205, 210, 215) can therefore access only the content items assigned to their respective user account. Thus user account 205 can access only content items 11 and 12, user account 210 can access only content item 13, and user account 215 can access only content items 14, 15 and 16.

FIG. 2B illustrates user accounts 205, 210 and 215 after they have been linked together to form a group of linked user accounts. As shown, user account 205 includes unique account identifiers 2 and 3 in the linked account field. This indicates that user account 205 is now linked to user accounts 210 and 215. Likewise, user account 210 includes the unique account identifiers 1 and 3 in its linked account field indicating that user account 210 is linked to user accounts 205 and 215, and user account 215 includes unique account identifiers 1 and 2 in its linked account field, indicating that user account 215 is linked to user accounts 205 and 210.

As a result of the user accounts 205, 210 and 215 being linked together, each of the user accounts (205, 210, 215) can access the content items assigned to the other user accounts, in addition to the content items assigned to the individual user account. For example, user account 205 can access content item 13 assigned to user account 210, and content items 14, 15 and 16 assigned to user account 215, in addition to the content items 11 and 12 assigned to user account 205. Likewise, user account 210 can access content items 11, 12, 14 15 and 16 in addition to the content items assigned to user account 210, and user account 215 can access content items 11, 12 and 13, in addition to the content items assigned to user account 215.

FIG. 2C illustrates user accounts 205, 210 and 215 after user account 205 has been removed from the group of linked user accounts. As shown, user account 215 no longer has any unique account identifiers listed in the linked account fields. This can indicate that user account 205 is no longer linked to any other user account. Further, the linked account fields of user accounts 210 and 215 have also been modified to remove the unique account identifier of user account 205, indicating that user accounts 210 and 215 are no longer linked to user account 205.

While user account 205 has been unlinked from user accounts 210 and 215, user accounts 210 and 215 remain linked to each other, as indicated by the linked account field of user accounts 210 and 215. As a result, user account 205 can access only the content items assigned to user account 205, and can no longer access the content items assigned to user accounts 210 and 215. Likewise, user accounts 210 and 215 can no longer access the content items assigned to user account 205, however user accounts 210 and 215 can still access the content items assigned to the other account. Thus, user account 205 can only access content items 11 and 12, whereas user accounts 210 and 215 can each access content items 13, 14, 15 and 16, but not content items 11 and 12.

Although listing unique account identifiers in a user account is used as one example of how user accounts can be linked together, this is only one possible embodiment and is not meant to be limiting. Linking multiple user account together can be performed in any of numerous ways known in the art.

In some embodiments, a unique group identifier can be used to identify a group of linked user accounts to which a user account belongs. A unique group identifier can identify one group of linked user accounts. Each user account can include a listing of unique group identifiers that identify each group of linked user accounts that include the user account belongs. A group index can be used to identify the user accounts included in each group of linked user accounts. For example, the group index can list each unique group identifier along with the unique account identifier for each user account included in the group. To identify the user accounts linked to a user account, the user account can be accessed to gather the group identifiers associated with the account. The group identifiers can then be used to search the group index to identify the user accounts included in each group.

Returning to the discussion of FIG. 1, in some embodiments, content management system 105 can be configured to enable user accounts in a group of linked user accounts to maintain a shared stream of content items that can be accessed by the other members of the group of linked user accounts, while maintaining a private stream of content items as well. For example, content management system 105 can enable users to designate whether content items should be included in a shared stream where the content item will be accessible with the members of the group of linked user account, or, alternatively, select to maintain the content item in a private stream such that the content item is only accessible to the user account to which the content item is assigned.

To accomplish this, content management system 105 can tag the content items to indicate whether they have been tagged to be shared or maintained as private. Content items tagged to be shared can be added to the shared stream where they can be accessed by the other members of the linked user accounts. Conversely, content items tagged to be maintained as private will be added to the private stream and thus can only be accessed by the user account to which the content item is assigned.

In some embodiments, one or more of the user accounts in a group of linked user accounts can be designated as a primary user account that can be enabled with additional functionality not provided to the subordinate user accounts in the group of linked user accounts. A subordinate user account can be a user account in the group of linked user account that is not designated as a primary user account.

In some embodiments, the user account used to create a group of linked user accounts can be designated the primary user account. Alternatively, a user account can be designated as the primary user account after the group of user accounts has been created; for example, after receiving authorization from the members of the group of linked user accounts that the user account should be the primary user account.

In some embodiments, the user account that provides the payment method used to make purchases for the group can be designated the primary user account. Alternatively, the user account designated the primary user account can be required to provide a valid payment method.

In some embodiments, a primary user account can be enabled to select and modify a payment method used by the group of linked user account, such as a credit or bank account that is used for all purchases. As another example, a primary user account can be enabled to add a user account to the group of linked user accounts and/or select to remove a user account from the group of linked user accounts.

In some embodiments, the primary user account can be enabled to set restrictions on the subordinate user accounts included in the group of linked user accounts. For example, content management system 105 can maintain control settings for each group of linked user accounts. The control settings for a group of linked user accounts can define restrictions on the individual user accounts in the group of linked user accounts.

In some embodiments, the control settings can be stored in a control setting index that can be a file assigned to a primary user account. For example, the control setting index can be stored in user account database 150 and associated with a primary user and/or the group of linked user accounts. This can provide the primary user account with read/write access to modify the control setting index and therefore modify the control settings. In contrast, the subordinate user accounts in the group of linked user accounts can be restricted to read only access to the control setting index, thereby restricting subordinate user accounts from modifying the control settings.

Content management system 105 can include control setting module 130 configured to enable a primary user account to modify the control settings and set restrictions on subordinate user accounts included in the group of linked user accounts. This can allow a parent to set restrictions on their child's user account.

Control setting module 130 can be configured to provide a control setting interface that enables the primary user account to modify the control settings for subordinate user accounts in the group of linked user accounts. For example, control setting interface 130 can communicate with user account database 150 to identify the subordinate user accounts linked to a primary user account, and then present the subordinate user accounts in the control setting interface, where the primary user account can set restrictions for the presented subordinate user accounts. Control setting module 130 can further be configured to access the control setting index to determine the current control settings for the group of linked user accounts.

The control setting interface can provide necessary tools to set the control settings for each subordinate user account. For example, the control setting interface can include buttons, dropdown menus, etc., that allow the primary user account to select and adjust the control settings for a subordinate user account. Control setting module 130 can record the selected control settings in the control setting index for the group of linked user accounts.

Upon receiving a request from client device 115ᵢ, content management system 105 can identify the user account authorized on client device 115ᵢ, (i.e. the user account that the client device 115 is logged into at the time the request is received), and access the control setting index for the corresponding group of linked user accounts. Content management system 105 can then determine whether the user account is restricted from performing the request. If content management system 105 determines that the request is restricted by the control settings, content management system 105 can deny the request. Alternatively, if content management system 105 determines from the control settings that the user account is not restricted from performing the request, content management system 105 can execute the request.

In some embodiments, the control setting index can be stored on client devices 115 as well as maintained by content management system 105. For example, control setting module 130 can transmit the control setting index to client devices 115 associated with the user accounts included in the group of linked user accounts. This can include client devices 115 authorized on a user account included in the group of linked user accounts. Client devices 115 can be configured to condition execution of requests based on the received control settings. For example, upon receiving a request, client device 115ᵢ can determine from the received control settings whether the request is prohibited and, if so, deny the request. Alternatively, if the request is not prohibited, client device 115ᵢ can execute the request.

Transmitting the control setting file to client devices 115 can allow the restrictions to be enforced while client devices 115 are not in network connection with content management system 105. For example, client device 115ᵢ can have content items stored locally in memory on client device 115ᵢ. Maintaining the control setting index locally on client device 115ᵢ allows client device 115ᵢ to access the control setting index while a network connection with content management system 105 is not available. For example, if a user requests to access a local content item on client device 115ᵢ client device 115 can check the local control setting index to determine whether to grant access to the requested content item.

In some embodiments, content management system 105 can be configured to manage a shared calendar for each group of linked user accounts. A shared calendar can be a unique calendar assigned to a group of linked user accounts that can be accessed by the members of the group of linked user accounts. The members of the group of linked user accounts can include the user accounts linked together to form the group of linked user accounts.

In some embodiments, only members of the group of linked user accounts can access the shared calendar assigned to the group of linked user accounts. Thus user accounts that are not members of a group of linked user accounts cannot access the shared calendar assigned to the group of linked user accounts. To receive authorization to access a shared calendar, a user account must become a member of the group of linked user accounts.

A shared calendar can provide the members of a group of linked user accounts a common calendar that can be accessed by each member to see upcoming scheduled calendar events, as well as receive reminders for scheduled calendar events. A calendar event can be a scheduled event on the shared calendar, such as a scheduled party, dinner, etc. This can allow a family to have a shared common calendar that can be accessed by each member of the family to set a family schedule and have reminders sent to each family member.

Content management system 105 can include calendar module 135 configured to generate and manage a shared calendar for a group of linked user accounts. To generate a shared calendar, calendar module 135 can generate a shared calendar index assigned to a group of linked user accounts. A shared calendar index can be a file or group of files that store calendar data representing calendar events received from the members of the group of linked user accounts. The calendar data can be used to generate the shared calendar by a requesting user's client device 115.

Content management system 105 can include calendar storage 170 configured to store shared calendars indexes for groups of linked user accounts. Calendar module 135 can be configured to communicate with calendar storage 170 to store a shared calendar index. Calendar module 135 can associate the shared calendar index with the corresponding group of linked user accounts. For example, calendar module 135 can tag the shared calendar index with an identifier that can be used to identify the corresponding group of linked user accounts. This can include a unique group identifier for the group of linked user accounts, and/or account identifiers for one or more of the members of the group of linked user accounts. For example, calendar module 135 can tag the shared calendar index with the unique account identifier for the primary user account in the group of linked user accounts.

Members of a group of linked user accounts can communicate with content management system 105 via client devices 115 to request calendar data for the shared calendar. Calendar module 135 can be configured to receive calendar requests from client devices 115, identify the corresponding shared calendar index, and transmit the requested calendar data to the requesting client devices 115. Client devices 115 can render the received calendar data to present the shared calendar.

Alternatively, in some embodiments, calendar module 135 can transmit the calendar data without receiving a request from client devices 115. For example, calendar module 135 can be configured to, periodically or in response to specified triggers, transmit calendar data to client devices 115 that are authorized on user accounts that are members of the group of linked user accounts.

In some embodiments, calendar module 135 can be configured to automatically generate a shared calendar for a group of linked user account when the group of linked user accounts is created. Linking module 125 can be configured to notify calendar module 135 when a new group of linked user accounts has been created and instruct calendar module 135 to generate a shared calendar for the group of linked user accounts.

Linking module 125 can pass data identifying the new group of linked user accounts to calendar module 125. For example, linking module 125 can pass a unique group identifier for the group of linked user accounts, account identifiers identifying some or all of the user accounts that are members of the group of linked user accounts, etc. Calendar module 135 can generate a shared calendar index for the group of linked user accounts and assign the shared calendar index to the group of linked user accounts identified by linking module 125.

In some embodiments, calendar module 135 can be configured to automatically update access to a shared calendar as the membership of a group of linked user accounts changes. For example, linking module 125 can be configured to notify calendar module 135 when a user account has been linked to a group of linked user accounts, and is thus a new member of the group of linked user accounts. Calendar module 135 can be configured to authorize the new member of the group of linked user accounts to access the shared calendar assigned to the group of linked user accounts, thereby enabling the new member of the group of linked user accounts to view calendar events associated with the shared calendar. To authorize a user account, calendar module 135 can add an account identifier for the newly added member to a listing of user accounts authorized to access the shared calendar. Further, calendar module 135 can transmit calendar data to client devices 115 authorized on the newly added user account.

Likewise, linking module 125 can be configured to notify calendar module 135 when a user account has been unlinked from a group of linked user accounts, and is thus no longer a member of the group of linked user accounts. Calendar module 135 can be configured to unauthorize the unlinked user account from the shared calendar assigned to the group of linked user accounts, thereby restricting the unlinked user account from accessing calendar events associated with the shared calendar. To accomplish this, calendar module 135 can remove an account identifier for the unlinked user account from a listing of user accounts authorized to access the shared calendar, thereby ensuring that calendar data will not be transmitted to the unlinked user account. Further, calendar module 135 can transmit a notification to client devices 115 authorized on the unlinked user account, notifying the client devices 115 that the user account has been unlinked from the group of linked user accounts and that any calendar data associated with the shared calendar that is available to the client device 115 should no longer be presented.

In some embodiments, calendar module 135 can be configured to enable the members of the group of linked user accounts to modify the shared calendar assigned to the group of linked user accounts. This can include adding, removing or modifying a calendar event. Calendar module 135 can be configured to receive an event request from client devices 115 authorized on a user account that is a member of the group of linked user accounts. An event request can be a request to add, delete or modify a calendar event on the shared calendar. Upon receiving an event request from a user account authorized to access the shared calendar, calendar module 135 can be configured to modify the shared calendar index assigned to the group of linked user accounts. Calendar module 135 can then transmit the updated calendar data to client devices 115 authorized on user accounts in the group of linked user accounts.

In some embodiments, calendar module 135 can be configured to provide varying permission levels to the members of the group of linked user accounts. For example, calendar module 135 can provide some members with read/write access to the shared calendar, thereby allowing these members to access calendar events and modify the shared calendar by adding, deleting or modifying a calendar event. In contrast, calendar module 135 can restrict some members of the group of linked user accounts to read only access, thereby allowing these members to access calendar events while restricting them from modifying the shared calendar by adding, deleting or modifying a calendar event.

Upon receiving an event request, calendar module 135 can be configured to determine the permission level assigned to the requesting user account and either grant or deny the event request accordingly. For example, upon determining that a user account has read only access, calendar module 135 can deny an event request to add, delete or modify an event request. Conversely, upon determining that a user account has read/write access, calendar module 135 can grant the event request.

In some embodiments, calendar module 135 can be configured to enable a primary user account to select the permission level for the members of the group of linked user accounts. Calendar module 135 can be configured to provide a permission interface that enables the primary user account to select whether the subordinate user accounts in the group of linked user accounts should have either read/write or read only access the shared calendar.

In some embodiments, calendar module 135 can be configured to assign a permission level to the members of the group of linked user accounts. For example, calendar module 135 can be configured to provide read/write access to only primary user accounts, whereas subordinate user accounts are assigned read only access. Alternatively, calendar module 135 can assign a permission level based on the age of the user. For example, calendar module 135 can be configured to assign user accounts with read only access when the user is younger than a predetermined age. Likewise, calendar module 135 can be configured to assign user accounts with read/write access when the user is older that a predetermined age.

In some embodiments, calendar module 135 can be configured to transmit reminder messages to the members of the group of linked user accounts. For example, calendar module 135 can transmit a reminder message to client devices 115 authorized on user accounts that are members of the group of linked user accounts. A reminder message can notify the receiving user that a calendar event is approaching. For example, calendar module 135 can be configured to transmit reminder messages a specified amount of time prior to the calendar event occurring, such as fifteen minutes prior.

In some embodiments, calendar module 135 can be configured to provide a shared task list to the group linked user accounts. A shared task list can be a common task list shared by the members of the group of linked user accounts that enables the members to access tasks added by members of the group of linked user accounts. A task can be any type of task, errand, appointment, etc. Similar to a shared calendar, a shared task list can be assigned to a group of linked user account and only be accessed by the members of the group of linked user accounts.

Calendar module 135 can generate and maintain a shared task list index that stores task data describing tasks added to the shared task list. This can include the details of the tasks as well as other data such as whether the task is active or completed, user(s) assigned to the task, user(s) that completed the task, etc. Calendar module 135 can tag a shared task list index with an identifier identifying the corresponding group of linked user accounts. For example, calendar module 135 can tag the shared task list with a group identifier for the group of linked user accounts. Calendar module 135 can store the shared task list in calendar storage 170.

Calendar module 135 can be configured to transmit task data to client devices 115 that are authorized on user accounts in the group of linked user accounts. Client devices 115 can render the received task data to display the shared task list. This can include rendering the tasks added to the task list and data describing the tasks.

Members of the group of linked user accounts can add tasks to the shared task list that can then be accessed and/or completed by the other members of the group of linked user accounts. For example, a shared calendar rendered on client devices 115 can include user interface elements, such as buttons, text fields, etc., that enable members of the group of linked user accounts to request to add a new task to the shared task list. The provided user interface elements can cause a requesting client device 115 to transmit a task request to content management system 105. A task request can be a request to add a task to the shared task list and can include metadata describing the task, such as details, an assigned user account, etc.

Calendar module 135 can be configured to receive task requests and add the task to the corresponding shared task list. Calendar module 135 can access the shared task index for the corresponding group of linked user accounts and add the task data for the received. Calendar module 135 can then update the members of the group of linked user accounts with the updated calendar data.

In some embodiments, calendar module 135 can be configured to enable members of a group of linked user mark a task as having been completed. Client devices 115 can render the shared task list to include user interface elements that enable the members of the group of the linked user accounts to indicate that a task included in the task list has been completed. Upon receiving an indication that a task has been completed, client devices 115 can transmit a task completion message to content management system 105 indicating that a specified task has been completed.

Calendar module 135 can be configured to receive task completion messages from client devices 115 and update the corresponding shared task list to indicate that the specified task has been completed. This can include modifying the appropriate task list index to reflect the changes status of the task to complete. Calendar module 135 can then update the members of the group of linked user accounts regarding the changes status of the task.

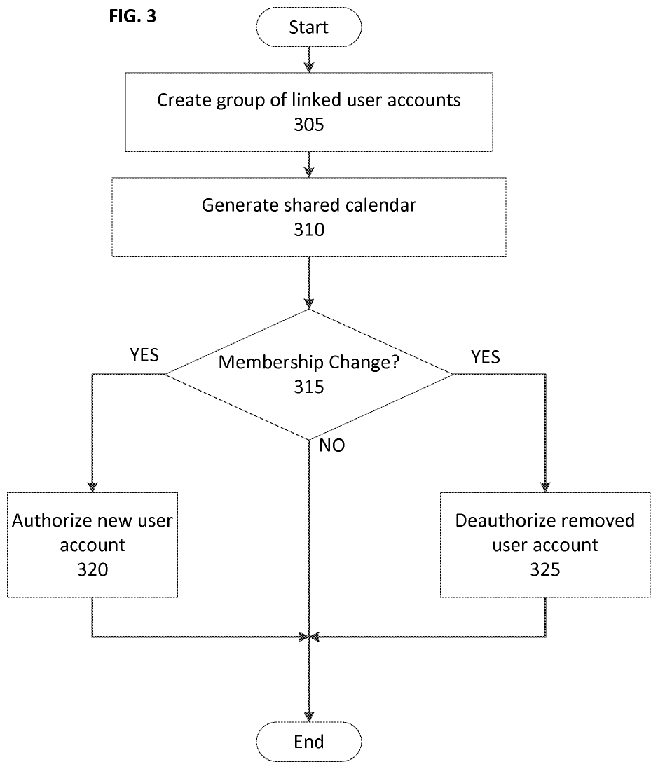

FIG. 3. illustrates an exemplary method embodiment of automatically generating a shared calendar for a group of linked user accounts. As shown, the method begins at bock 305 where a new group of linked user accounts is created. One or more user accounts can be linked together to form a group of linked user accounts. When linked, the user accounts in the group of linked user accounts can access content items assigned to the other user accounts in the group of linked user accounts. This can allow family members to link their accounts into a group of linked user accounts to share their purchases, photos, etc. with the other members of their family.

At block 310 a shared calendar is generated for the group of linked user accounts. This can include generating a shared calendar index assigned to the group of linked user accounts. A shared calendar index can store calendar data describing calendar events on the shared calendar. For example, calendar data can include a description of an event, a time of the event, location of the event, etc.

The generated shared calendar index can be tagged with an identifier identifying its corresponding group of linked user accounts. For example, the shared calendar index can be tagged with a unique group identifier for the group of linked user accounts. Alternatively, the shared calendar index can be tagged with account identifiers for one or more of the user accounts included in the group of linked user accounts.

At block 315, it is determined whether the membership of group of linked user accounts has been modified. For example, it can be determined whether the membership of the group of linked user accounts has been changed to add or remove of user account to/from the group of linked user accounts. The list of user accounts that can access the shared calendar is dynamic and changes as the membership of the group of linked user accounts changes.

If at block 315 it is determined that the group of linked user accounts has been modified to add a new user account, the method continues to block 320 where the new user account is authorized to access the shared calendar, whereby the user account can access calendar events added to the shared calendar by members of the group of linked user accounts.

Alternatively, if at block 315 it is determined that the group of linked user accounts has been modified to remove a user account that was a member of the group of linked user accounts, the method continues to block 325 where the removed user account is unauthorized to access the shared calendar. Once unauthorized, the user account can no longer access the shared calendar and/or the calendar events added to the shared calendar by the members of the group of linked user accounts.

Returning to the discussion of FIG. 1, content management system 105 can be configured to enable users to create a group of linked user accounts. For example, content management system 105 can be configured to receive a group creation request from a client device 115ᵢ. A group creation request can be a request from a user account to create a group of linked user accounts.

In response to receiving a group creation request, linking module 125 can be configured to initiate the process of creating a group of linked user accounts. In some embodiments, linking module 125 can require that a requesting user be signed into their user account (e.g., authorized to access the user account) to create a group of linked user accounts. If the requesting user is not signed into their user account, linking module 125 can prompt the user to do so.

In some embodiments, the user account requesting to create a group of linked user accounts can be designated as a primary user account (called an organizer), but only if the user account used to create the group of linked user account is known to be an adult (e.g., over 18 years of age). Linking module 125 can be configured to require the requesting user account to be of a specified age and/or provide a valid payment method. For example, linking module 125 can require that the requesting user be at least 18 years of age and provide a valid credit card. Linking module 125 can be configured to terminate the group creation process if the age and payment method requirements are not met.

Linking module 125 can be configured to prompt a requesting user account to identify the user accounts and/or users that the requesting user would like to add to the group of linked user accounts. For example, linking module 125 can prompt the requesting user account to enter contact information such as an e-mail address for the users that the requesting user would like to add to the group of linked user accounts. Alternatively, in some embodiments, linking module 125 can prompt the requesting user account to enter account information identifying the user accounts that the requesting user would like to add to the group of linked user accounts.

In some embodiments the linking module 125 can determine whether an invited user is an adult, and if not, the requesting user can be prompted to put in place optional account restrictions. In some embodiments, the requesting user may want to add a minor to the group of linked user account (e.g., a parent may wish to add a child), but the minor does not have an existing user account. In such embodiments, the requesting user can be allowed to create a user account for the minor subject to the optional account restrictions.

In some embodiments, linking module 125 can enable a requesting user to enter the user credentials for an invited user account. A requesting user can then enter an invited user's credentials and the invited user can be added to the group of linked user accounts immediately. In some embodiments, linking module 125 can be configured to transmit invitations to the invited users/user accounts to join the group of linked user accounts so that the invited user can enter their own credentials. For example, if the requesting user does not know the credentials for the invited users, the requesting user can request that the invitations be sent to the invited users.

The invitations can be transmitted using the contact information provided by the requesting user and/or to client devices authorized on identified user accounts. The invitations can be a message notifying the invited user that they have been invited to join a group of linked user accounts. Further, the invitations can be configured to enable the invited user to select whether to accept or deny the invitation to join the group of linked user accounts. For example, the invitation can include user interface elements that enable the invited user to select whether to accept or deny the invitation. Selection of a user interface element provided in the invitation can cause the invited user's client device 115ᵢ to transmit a response message to content management system 105 indicating the invited user's selection. For example, the response message can indicate whether the invited user selected to accept or decline the invitation to join the group of linked user accounts.

In some embodiments, linking module 125 can be configured to prompt an invited user to log into or create a user account with content management system 105 if the invited user does not already have a user account. For example, if a requesting user invites an invited user to join a group of linked user accounts and the invited user does not have a user account, linking module 125 can prompt the invited user to create a user account. This can include providing the invited user with an account creation interface enabling the invited user to create a user account. Upon creation of the user account, linking module 125 can prompt the invited user to add the created user account to the group of linked user account and/or add the created user account to the group of linked user accounts.

In some embodiments, linking module 125 can be configured to determine whether an invited user has an existing user account with content management system 105. For example, if a requesting user provides contact information, such as an e-mail address, for a user that the requesting user would like to invite to join a group of linked user accounts, linking module 125 can determine whether the invited user already has a user account. Linking module 125 can determine whether the provided contact information is associated with an existing user account.

If linking module 125 determines that the contact information is associated with an existing user account, linking module 125 can determine that the invited user has an existing user account. Alternatively, in some embodiments, if linking module 125 determines that the contact information is associated with an existing user account, linking module 125 can query the invited user regarding whether the identified user account is the invited user's account and whether the invited user would like to add the identified user account to the group of linked user accounts.

Alternatively, in some embodiments, linking module 125 can be configured to select contact information for an invited user that is associated with a user account on content management system 105. For example, a requesting user can select a saved contact to invite to join a group of linked user accounts, and the saved contact may be associated with multiple available contact methods, such as multiple e-mail addresses, phone numbers, etc. Linking module 125 can determine if any of the available contact methods is associated with an existing user account and, if so, determine that the invited user has an existing user account. Linking module 125 can then transmit an invitation to the invited user to add their existing user account to the group of linked user accounts.

In some embodiments, the invitations transmitted to invited users can be configured to determine whether the invited user has an existing user account. For example, the invitation can include executable code that, when executed, queries the executing client device 115 to determine whether the client device is authorized on a user account of content management system 105. If the executing client device is authorized on a user account, the invited user can be invited to add the user account to the group of linked user accounts. For example, the executable code can cause the invitation to populate information identifying the user account into the invitation presented to the invited user.

In some embodiments, linking module 125 can enable users to select sharing parameters. For example, a user may wish to join a group of linked user accounts, however wish to limit the content items that are shared with the other members of the group of linked user accounts. Linking module 125 can provide users with an interface that enables users to select the level of sharing that the user is willing to participate in. For example, the user can select to limit the content items shared with the members of the group of linked user accounts to specified types of content items such as movies, music, books, etc. As another example, a user may select to limit the content items shared with other members of the group of linked user accounts to content items purchased by the user.

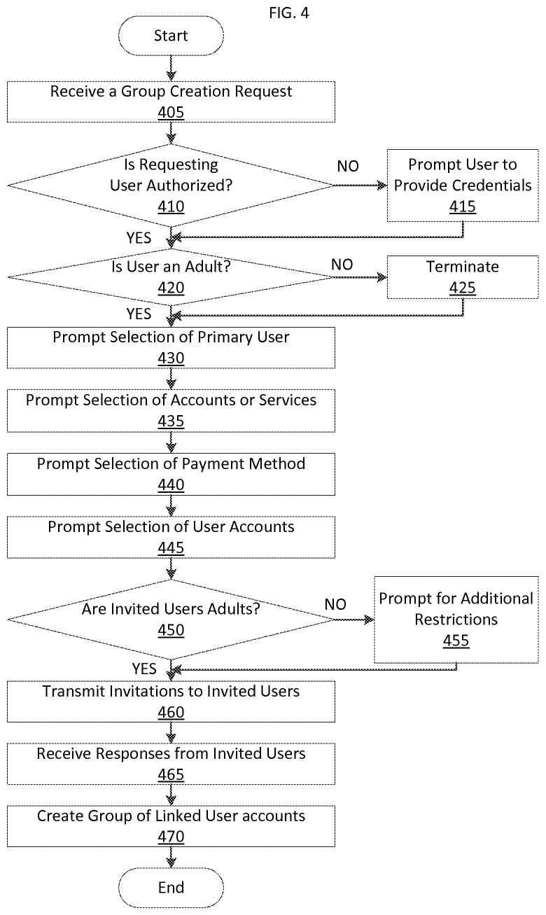

FIG. 4 shows an exemplary method of creating a group of linked user accounts. The method is described in view of the system illustrated in FIG. 1. As shown, the method begins at block 405 where content management system 105 receives a group creation request from a client device 115ᵢ. A group creation request can be a request from a user to create a group of linked user accounts.

At block 410, linking module 125 can determine whether the requesting user is authorized on a user account maintained by content management system 105. For example, linking module 125 can determine whether the user provided user credentials associated with a user account maintained by content management system 105.

If at block 410, linking module 125 determines that the requesting user is not authorized on a user account, the method continues to block 415 where linking module 125 prompts the user to provide credentials associated with a user account. For example, linking module 125 can transmit data to the requesting user's client device 115ᵢ to prompt the user to enter credentials (e.g., a user name and password) to authorize the client device 115ᵢ on a user account.

Alternatively, if at block 410 linking module 125 determines that the requesting user is authorized on a user account, the method continues to block 420 where linking module 125 determines whether the requesting user is an adult. For example, linking module 125 can communicate with user account database 150 and gather user data, such as the user's date of birth, from the requesting user's account to determine whether the requesting user is an adult.

If at block 420, linking module 125 determines that the requesting user is not an adult, the method can continue block 425 where linking module 125 terminates creation of the group of linked user accounts. For example, the linking module 125 can transmit a message to the requesting user's client device 115ᵢ notifying the requesting user that only adults can create a group of linked user accounts. The method can then end.

Alternatively, if at block 420 linking module 125 determines that the requesting user is an adult, the method continues to block 430 where the requesting user is prompted to select a primary user account for the group of linked user accounts. For example, the requesting user can select his/her user account to be the primary user account for the group of linked user accounts or, alternatively, another user account to be the primary user account.

At block 430, linking module 125 can prompt the requesting user to select accounts or services to be included in the group of linked user accounts. For example, a requesting user may be associated with multiple user accounts and want only one user account to be included in the group of linked user accounts. Alternatively, the requesting user may only want certain features, functionality or services to be shared as part of the group of linked user accounts. For example, the requesting user may only want to have songs or movies shared as part of the group of linked user accounts. Alternatively, the requesting user may only want location or calendar data be shared as part of the group of linked user accounts. Linking module 125 can prompt the requesting user to select the accounts or services that the requesting user would like to include as part of the group of linked user accounts and create the group of linked user accounts according to the requesting user's provided selections. In some embodiments, this may include prompting the requesting user to provide login credentials for any selected accounts or services.

At block 440, linking module 125 can prompt the requesting user to enter payment information for the group of linked user accounts. For example, linking module 125 can require that a primary user provide payment information, such as credit card information, that will be used for purchases made by each member of the group of linked user accounts. Linking module 125 can transmit a message to the requesting user's client device to enter the payment information, which can then be assigned to the group of linked user accounts.

At block 445, linking module 125 can prompt the requesting user to select user accounts to add to the group of linked user accounts. For example, the requesting user can be prompted to enter information identifying user accounts to add to the group of linked user accounts, such as user names, e-mail addresses, etc. Linking module 125 can also prompt a user to select users from the user's address book to add to the group of linked user accounts.

In some embodiments, a user can create a user account to be added to the group of linked user accounts. For example, a parent may wish to add his/her child to the group of linked user accounts. Linking module 125 can enable a requesting user to create user accounts to be added to the group of linked user accounts.

At block 450, linking module 125 can determine whether the user's associated with the identified user accounts are adults. For example, linking module 125 can access the user's corresponding user accounts to determine their age. If at block 450, linking module 125 determines that a user is not an adult, the method can continue to block 455 where linking module 125 can enable the requesting user to add additional restrictions to the associated user account. For example, a parent may wish to restrict the types of movies, pictures, etc., that can be accessed by a child. Linking module 125 can enable the requesting user to place desired restrictions on the user account of a minor.

At block 460, linking module 125 can transmit invitations to the users that are invited to join the group of linked user accounts. For example, linking module 125 can transmit messages to client device 115 associated with the user accounts. Alternatively, linking module 125 can transmit e-mail messages to the users. The invitations can enable the invited user to choose to accept or decline the invitation to enter the group of linked user accounts. For example, the invitations can include user interface elements that enable the invited user to select to accept or decline the invitation to join the group of linked user accounts.

In some embodiments, the invitation can prompt an invited user to nter their account credentials to accept the invitation to the group of linked user accounts. Further, the invitation can enable an invited user to select accounts, services that the user would like to include in the group of linked user accounts. For example, a user may wish to only share certain data, types of content items, etc., with the group of linked user accounts.

At block 465, linking module 125 can receive responses from the invited users. For example, the responses can indicate whether the invited users accepted or declined the invitation, as well as any selections regarding the types of data, content items, etc., which the users would like to share with the group of linked user accounts.

At block 470, linking module 125 can create the group of linked user accounts according to the responses received from the invited users. For example, linking module 125 can include the user accounts of invited user that accepted the invitation to join the group of linked user accounts.

Returning to the discussion in FIG. 1, in some embodiments, location module 140 can be configured to automatically update the user accounts and client devices from which location data is gathered and shared. For example, location module 140 can be configured to determine that a user accounts has been added and/or removed from a group of linked user accounts and automatically update the corresponding location index to indicate that the user account has been added or removed from the group of linked user accounts. Location module 140 can be configured to gather location data from the newly added user account and update the members of the group of linked user accounts.

In some embodiments, content management system 105 can be configured to gather and share location data amongst members of a group of linked user accounts. The members of the group of linked user accounts can include the user accounts linked together to form the group of linked user account. Location data can be data describing the location of a user and/or client devices 115. For example, location data can include geographic coordinates describing a specific geographic location.

Content management system 105 can include location module 140 configured to gather location data from client devices 115 and share the gathered location data with members of a group of linked user accounts. To accomplish this, location module 140 can be configured to identify client devices 115 that are authorized on user accounts that are members of the group of linked user accounts. This can include multiple client devices 115 that are authorized on a single user account. For example, a user can have multiple client devices, such as a tablet PC, smartphone and laptop, that are each authorized on the user's user account.

Location module 140 can be configured to maintain a location index for each group of linked user accounts. A location index can be a file or group of files that identifies the members of the group of linked user accounts, the client devices authorized on the user accounts, as well as location data gathered from the client devices. Location module 140 can tag each location index with a unique group identifier for the group of linked user accounts corresponding to the location index. Content management system 105 can include location storage 175 configured to store location indexes. Location module 140 can be configured to communicate with location storage 175 to store and access location indexes.

Location module 140 can be configured to request location data from client devices 115. For example, location module 140 can transmit a location query to client devices 115 that requests location data from the client devices 115. In response to receiving a location query, client devices 115 can transmit location data to content management system 105. Location module 140 can record the received location data in the corresponding location index in location storage 175.

In some embodiments, client devices 115 can be configured to transmit location to content management system 105 without being prompted by content management system 105. For example, client devices 115 can be configured to transmit location data to content management system 105 according to a predetermined schedule, such as every 10 or 15 minutes. Alternatively, client devices 115 can be configured to transmit location data to content management system 105 upon a location trigger occurring. A location trigger can be any type of predetermined trigger. For example, a location trigger can be a change in state of a client device such as the client device turning on/off, turning network capability on/off, connecting to a specified network connection, etc. Alternatively, a location trigger can be based on movement of a client device, such as a determination that the client device has moved at least a predetermined distance within a specified period of time.

Client devices 115 can gather location data in numerous ways. In some embodiments, client devices 115 can include a GPS component configured to determine the current location of a client device 115. Alternatively, the location data can be gathered from an IP address or local network utilized by a client device. Alternatively, the location data can be gathered from data provided by a user of the client device.

Location module 140 can be configured to transmit the location data gathered from members of a group of linked user accounts to the other member of the linked user accounts. For example, location module 140 can be configured to receive location requests from client devices 115 that requests location data for members of a group of linked user accounts. In response, location module 140 can transmit the requested location data to the requesting client devices 115.

Client devices 115 can be configured to present the received location data to represent the location of the other members of the group of linked user accounts and the location of their client devices 115. For example, the location data can be visually represented on map interface. Further, the location data can include a label for each client device and user to indicate the client device/user that is at each represented location.

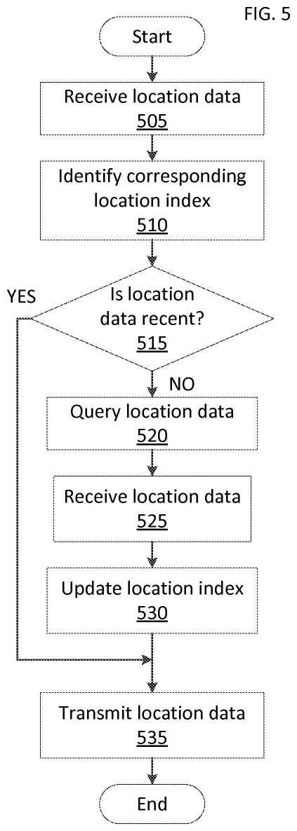

FIG. 5 illustrates an exemplary method embodiment of sharing location data amongst members of a group of linked user accounts, which will be discussed in view of the system described in FIG. 1. As shown, the method begins at block 505 where content management system 105 receives a location request from a client device 115ᵢ. A location request can be a request for location data gathered from members of a group of linked user accounts. For example, the location data can be data describing the geographic location of the client devices 115 authorized on user accounts that are members of the group of linked user accounts.

At block 510 location module 140 identifies the corresponding location index for the group of linked user accounts. To accomplish this, location module 140 can identify the user account authorized on the requesting client device 115ᵢ, and identify the group of linked user accounts to which the user account is a member. Location module 140 can then identify the corresponding location index in location storage 175. For example, location module 140 can search for the location index tagged with the group identifier for the group of linked user accounts.

At block 515, location module 140 can determined whether the location data in the location index is recent. For example, location module 140 can determine whether the location data received for the client devices listed in the location index has been updated within a predetermined amount of time. If location module 140 determined that the location data is recent, i.e. the location data has been received within the predetermined amount of time, the method can continue to block 555 where location module 140 can transmit the location data to the requesting client device 115ᵢ. The requesting client device 115ᵢ can present the received location data, thereby identifying the geographic location of the client devices authorized on user accounts of the group of linked user accounts.

Alternatively, if at block 515 location module 140 determines that the location data in the location data index is not recent, i.e. the location data was not received within a predetermined amount of time, the method continues to block 520 where the location module 140 queries client devices 115 that are authorized on user accounts of the group of linked user accounts for location data. This can include location module 140 transmitting a location query to the client devices requesting that the client devices 115 return location data.

At block 525, content management system 105 receives location data from the client devices 115 in response to the location queries. The location data can be data describing the geographic coordinates of the client devices 115.

At block 530, location module 140 can record the received location data in the corresponding location index.

At block 535, location module 140 can transmit the location data to the requesting client device 115ᵢ. The requesting client device 115ᵢ can present the received location data, thereby identifying the geographic location of the client devices authorized on user accounts of the group of linked user accounts.

Returning to the discussion of FIG. 1, in some embodiments, location module 140 can be configured to automatically update the user accounts and client devices from which location data is gathered and shared. For example, location module 140 can be configured to determine that a user accounts has been added and/or removed from a group of linked user accounts and automatically update the corresponding location index to indicate that the user account has been added or removed from the group of linked user accounts. Location module 140 can be configured to gather location data from the a newly added user account and update the members of the group of linked user accounts.

FIG. 7 illustrates an exemplary method embodiment of automatically updating the user accounts that are sharing location data with each other. The method is described in view of the system described in FIG. 1. As shown, the method begins at block 705 where content management system 105 creates a group of linked user accounts. For example, linking module 125 can link multiple user accounts to create a group of linked user account.

At block 710, location module 140 can identify the client devices 115 authorized on user accounts that are members of the group of linked user accounts. In some cases, multiple client devices 115 can be authorized on a single user account. For example, a user may have multiple computing devices that the user has authorized to access their user account.

At block 715, location module 140 generates a location index for the group of linked user account. A location index can be one or more files assigned to a group of linked user accounts that list the user accounts in the group of linked user accounts, the client devices authorized on the user accounts and location data gathered from the user accounts. Location module 140 can tag the location index with a group identifier for the group of linked user accounts. Further, location module 140 can store the generated location index in location storage 175.

At block 720, location module 140 can gather location data from the client devices 115 authorized on user accounts that are members of the group of linked user accounts. Location module 140 can transmit location queries to the client devices 115 that request that the client devices 115 return location data to content management system 105. In response, client devices 115 can transmit location data to content management system 105.

At block 725, location module 140 can update the corresponding location index to include the gathered location data, and the, at block 730, transmit the gathered location data to the members of the group of linked user accounts. This can include transmitting the location data to client devices 115 authorized on user accounts that are members of the group of linked user accounts. Alternatively, linking module 125 can transmit the location data to client devices 115 specified by the user accounts to receive the location data. For example, a user may designate one client device to receive the location data gathered from the group of linked user accounts.

At block 735, location module 140 determines whether there has been a membership change to the group of linked user accounts. For example, linking module 125 can be configured to update location module 140 when a group of linked user accounts has been updated to add or remove a group of linked user accounts.

If at block 735, location module 140 determines that a membership change has occurred, the method continues to block 740, where location module 140 determines whether an account was added to the group of linked user account.

If at block 740, location module 140 determines that a user account was not added to the group of linked user account, meaning that a user account was removed from the group of linked user account, the method continues to block 755 where linking module 140 can update the corresponding location index. This can include modifying the linking index to remove the user account that has been removed from the group of linked user accounts, as well as the client devices authorized on the user account and any corresponding location data. As a result, location data will no longer be gathered from the removed user account and future transmissions of location data to members of the group of linked user accounts will not include location data gathered from the removed user account or be transmitted to the removed user account.

If at block 740, location module 140 determines that a user account was added to the group of linked user accounts, the method continues to block 745 where location module 140 identifies client devices authorized on the added user account.

At block 745, location module 140 gathers location data from the added user accounts and at block 755 location module 140 updates the corresponding location index to include the added user account, client devices and gathered location data.

Returning to the discussion of FIG. 1, in some embodiments, the location data shared with client devices 115 can be used to present the location of one or more of the client device 115 that are authorized on the user accounts of the group of linked user accounts. For example, a user can request to receive the location of a specified client device or devices. The user can communicate with content management system via client device 115ᵢ t request the location data from the specified device(s). This can enable the user to identify the location of a specific client device that may be lost. In response, content management system 105 can return the location data for the requested client device(s) 115.

Alternatively, in some embodiment, the location data can be used to identify the location of the other members of the group of linked user accounts. Each user account can have one designated client device 115 that is considered to represent the location of the user associated with the user account. For example, each user's mobile phone can be used to identify the location of the user since most users carry their mobile phones with them at all time. A user can communicate with content management system 105 via client device 115ᵢ to request the location of one or more members of the group of linked user accounts. In response, content management system 105 can return the location data for the client devices 115 that are designated to represent the location of the specified members of the group of linked user accounts. For example, content management system 105 can transmit location data for the primary mobile phone of each specified member of the group of user accounts.

In some embodiments, content management system 105 can be configured to enable the members of the group of linked user accounts to execute lost device features on the client devices 115 of the other members of the group of linked user accounts. Lost device features can be features that can be executed remotely on a client device 115ᵢ when the client device 115ᵢ is lost. For example, a lost device feature can include remotely causing a client device 115ᵢ to play a sound that can help in identifying the location of the client device 115ᵢ. Another lost device feature can be remotely causing the client device 115ᵢ to lock and present a message indicating that the client device 115ᵢ has been lost. In some embodiments, this can include presenting contact information on the client device 115ᵢ to contact an owner of the client device 115ᵢ and/or enabling the client device 115ᵢ to only contact the presented contact information. Another lost device feature can be remotely causing the client device 115ᵢ to erase its contents.

To initiate a lost device feature, a user can communicate with content management system 105 using client device 115ᵢ to request that a specified lost device feature be remotely executed on one or more specified client device(s) 115. In response, content management system 105 can transmit a command to the specified client device(s) to execute the requested lost device feature.

FIG. 7A, and FIG. 7B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 7A illustrates a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 755 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B illustrates a computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that exemplary systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A non-transitory computer readable medium comprising computer readable code executable by one or more processors to:
receive, at a first device, a request to create a user group;
identify a first user account from which the request is received;
provide a first prompt for input of a second user account to be included in the user group;
provide a second prompt for pre-defined user credentials for the second user account;
provide a third prompt for selection of services to be shared by the user group; and
cause the user group to be created, wherein the user group includes the first user account and the second user account based on the pre-defined user credentials, wherein the first user account and the second user account are linkable by a content management system, and wherein the selected services are accessible to the first user account and the second user account based on membership of the user group.

2. The non-transitory computer readable medium of claim 1, wherein the second prompt comprises a first option to enter the pre-defined user credentials for the second user account at the first device and a second option to transmit an invitation message to a second device associated with the second user account to prompt entry of the pre-defined user credentials for the second user account.

3. The non-transitory computer readable medium of claim 1, wherein, upon creation of the user group, the first user account is granted access to calendar data associated with the second user account and the second user account is granted access to calendar data associated with the first user account.

4. The non-transitory computer readable medium of claim 1, wherein, upon creation of the user group, the first user account and the second user account are granted access to a shared calendar associated with the group of linked user accounts.

5. The non-transitory computer readable medium of claim 1, wherein, upon creation of the user group, the first user account and the second user account are granted access to a shared task list associated with the group of linked user accounts.

6. The non-transitory computer readable medium of claim 1, wherein, upon creation of the user group, the first user account is granted access to location information for a second device, and the second user account is granted access to location information for the first device.

7. The non-transitory computer readable medium of claim 1, further comprising computer readable code to:
detect that the second user account has been removed from the group of linked user accounts; and
in response to detecting that the second user account has been removed from the group of linked user accounts, disable access of the second user account to the selected services.

8. A system comprising:
a content management system configured to maintain one or more user accounts associated with one or more users; and
one or more processors comprising computer readable code executable by the one or more processors to:
receive, at a first device, a request to create a user group;
identify a first user account of the one or more user accounts from which the request is received;
provide a first prompt for input of a second user account of the one or more user accounts to be included in the user group;
provide a second prompt for pre-defined user credentials for the second user account;
provide a third prompt for selection of services to be shared by the user group; and
cause the user group to be created, wherein the user group includes the first user account and the second user account based on the pre-defined user credentials, wherein the first user account and the second user account are linkable by the content management system, and wherein the selected services are accessible to the first user account and the second user account based on membership of the user group.

9. The system of claim 8, wherein the second prompt comprises a first option to enter the pre-defined user credentials for the second user account at the first device and a second option to transmit an invitation message to a second device associated with the second user account to prompt entry of the pre-defined user credentials for the second user account.

10. The system of claim 8, wherein, upon creation of the user group, the first user account is granted access to calendar data associated with the second user account and the second user account is granted access to calendar data associated with the first user account.

11. The system of claim 8, wherein, upon creation of the user group, the first user account and the second user account are granted access to a shared calendar associated with the group of linked user accounts.

12. The system of claim 8, wherein, upon creation of the user group, the first user account and the second user account are granted access to a shared task list associated with the group of linked user accounts.

13. The system of claim 8, wherein, upon creation of the user group, the first user account is granted access to location information for a second device, and the second user account is granted access to location information for the first device.

14. The system of claim 8, wherein the one or more processors further comprise computer readable code executable by the one or more processors to:
detect that the second user account has been removed from the group of linked user accounts; and
in response to detecting that the second user account has been removed from the group of linked user accounts, disable access of the second user account to the selected services.

15. A method comprising:
receiving, at a first device, a request to create a user group;
identifying a first user account from which the request is received;
providing a first prompt for input of a second user account to be included in the user group;
providing a second prompt for pre-defined user credentials for the second user account;
providing a third prompt for selection of services to be shared by the user group; and
causing the user group to be created, wherein the user group includes the first user account and the second user account based on the pre-defined user credentials, wherein the first user account and the second user account are linkable by a content management system, and wherein the selected services are accessible to the first user account and the second user account based on membership of the user group.

16. The method of claim 15, wherein the second prompt comprises a first option to enter the pre-defined user credentials for the second user account at the first device and a second option to transmit an invitation message to a second device associated with the second user account to prompt entry of the pre-defined user credentials for the second user account.

17. The method of claim 15, wherein, upon creation of the user group, the first user account is granted access to calendar data associated with the second user account and the second user account is granted access to calendar data associated with the first user account.

18. The method of claim 15, wherein, upon creation of the user group, the first user account and the second user account are granted access to one or more of a group consisting of a shared calendar associated with the group of linked user accounts and a shared task list associated with the group of linked user accounts.

19. The method of claim 15, wherein, upon creation of the user group, the first user account is granted access to location information for a second device, and the second user account is granted access to location information for the first device.

20. The method of claim 15, further comprising:
detecting that the second user account has been removed from the group of linked user accounts; and
in response to detecting that the second user account has been removed from the group of linked user accounts, disabling access of the second user account to the selected services.
